(19) United States
(12) Patent Application Publication
(10) Pub. No.: US 2013/0213216 A1
(43) Pub. Date: Aug. 22, 2013

(54) System For Controlling a Stabilizing Foot, Stabilization Device, and Vehicle Including a Stabilization Device

(71) Applicant: Didier Camus, Charleville-Mezieres (FR)

(72) Inventor: Didier Camus, Charleville-Mezieres (FR)

(73) Assignee: EGI, Charleville-Mezieres (FR)

(21) Appl. No.: 13/883,174

(22) PCT Filed: Nov. 2, 2011
(86) PCT No.: PCT/IB11/54873

§ 371 Date: May 2, 2013

(30) Foreign Application Priority Data
Nov. 3, 2010 (FR) 1059053

(51) Int. Cl. F15B 15/00

(52) U.S. Cl. CPC F15B 15/00
USPC 92/143

(57) ABSTRACT

The system according to the invention for controlling a stabilizing foot (112) includes a hydraulic cylinder (116) and a hydraulic circuit (124) for supplying hydraulic fluid to the hydraulic cylinder, the hydraulic cylinder (116) including a cylinder rod (114), at the end of which the stabilizing foot (112) can be attached, and at least one hydraulic chamber (118) controlling the position of the cylinder rod (114), the hydraulic supply circuit (124) including an arm (126) for supplying to the hydraulic chamber (118), comprising first means (138) that can be selectively actuated to prevent the flow of the hydraulic fluid from the hydraulic cylinder, and second means (130, 136) for preventing a flow of the hydraulic fluid from the hydraulic cylinder while the pressure of the hydraulic fluid in the hydraulic chamber is lower than a predetermined threshold value, the second means (136) being arranged between the first means (138) and the hydraulic chamber (118).

The present invention relates to a system for controlling a stabilizing foot, a stabilization device including a stabilizing foot, and a vehicle, in particular a hoisting engine, comprising a stabilization device.

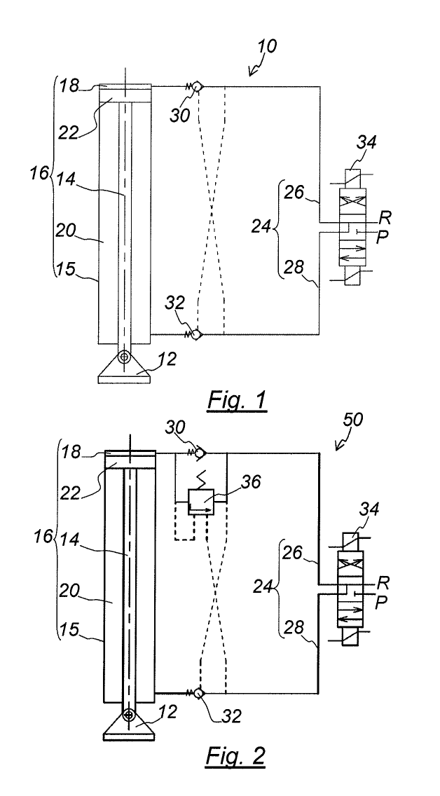

Known is a stabilization device 10 for a hoisting engine as shown in FIG. 1. This stabilization device 10 includes a stabilizing foot 12 attached to the rod 14 of a double-action hydraulic cylinder 16. The cylinder 16 thus includes two hydraulic chambers 18, 20 separated by a piston 22 secured to the rod 14. A piston joint is provided at the piston 22 to ensure sealing against the hydraulic fluid between the two chambers 18, 20.

The stabilization device 10 further includes a circuit 24 supplying hydraulic fluid to each of the chambers 18, 20 of the hydraulic cylinder. This supply circuit 24 may selectively be connected to a pressurized hydraulic fluid source P and/or a hydraulic fluid reservoir R. The supply circuit 24 includes two arms 26, 28, each of said arms 26, 28 being provided with a controlled check valve 30, 32, making it possible to prevent hydraulic fluid from being discharged outside either of the two chambers 18, 20. Each check valve may be made up of a closure element elastically stressed in a position closing a passage orifice of the hydraulic fluid.

The supply circuit 24 also includes a three-position valve 34. Two positions of said valve 34 make it possible to fill one 18, 20 of the two chambers while allowing emptying of the other 20, 18. In the third position of the valve 34, the supply circuit 24 is isolated from the pressurized hydraulic fluid source P. The two arms 26, 28 of the hydraulic circuit are then in fluid communication with the hydraulic fluid reservoir R, thereby allowing the check valves to be in the closing position thereof, preventing the flow of hydraulic fluid.

Such a stabilization device operates as follows. To ensure the stability of the hoisting engine, a supply of hydraulic fluid to the chamber 18 by means of the arm 26 of the hydraulic circuit is commanded. At the same time, a diversion (illustrated by the dotted lines in FIG. 1) is done for a quantity of pressurized hydraulic fluid from the arm 26 toward the check valve 32. This makes it possible to keep said check valve 32 in the position thereof where it allows the hydraulic fluid to pass from the hydraulic chamber 20 toward the hydraulic fluid reservoir R. Subsequently, the hydraulic fluid chamber 18 fills with hydraulic fluid, and the hydraulic fluid chamber 20 simultaneously empties. The combination of these two phenomena causes the cylinder rod 14 to exit the cylinder body 15, until a stabilized position of the hoisting engine is reached. In this position, the stabilizing foot 12 is in contact with the ground. The valve 34 is then closed, in the position shown in FIG. 1. The two valves 30, 32 then automatically return to their closing position, preventing the flow of hydraulic fluid from the hydraulic chambers 18, 20. The quantity of hydraulic fluid contained in each of the chambers 18, 20 then no longer varies and the position of the rod is ensured.

Such a device effectively makes it possible to ensure the stability of the hoisting engine in most cases. However, in the event of a failure of the hydraulic cylinder, related to a piston joint failure for example, deformation of the cylinder body may occur. In that case, in fact, hydraulic fluid escapes from the hydraulic chamber 18 toward the hydraulic chamber 20. The pressure equalizes between the two chambers and increases in the ratio of the cross-sections of the surfaces of the piston. An unanticipated hydraulic overload then occurs in the cylinder. Such a failure may lead to the very destruction of the hydraulic cylinder due to explosion.

To avoid this destruction of the cylinder, a stabilization device 50 as illustrated in FIG. 2 is known. In said FIG. 2, the elements that are identical or perform an identical function to the elements of the stabilization device 10 of FIG. 1 bear the same references.

As illustrated in said FIG. 2, the stabilization device 50 includes, in parallel with the check valve 30, a balancing valve 36. This balancing valve enables the discharge of a quantity of hydraulic fluid outside the chamber 18 of the cylinder 16 in the case where the fluid in that chamber reaches a predetermined pressure value.

Thus, if an increase in the pressure of the hydraulic fluid appears following an unanticipated load on the stabilization device—for example in the event the usage diagram of the hoisting engine is exceeded—then the balancing valve opens and thereby prevents deterioration of the cylinder 16 due to an excessive increase in the pressure of the hydraulic fluid in the hydraulic chamber of the cylinder.

However, the balancing valves may be adjusted unsuitably. In particular, the balancing valves may allow a discharge of hydraulic fluid at a too low pressure. In that case, the hydraulic chamber empties while the cylinder may support the pressure of the hydraulic fluid in the hydraulic chamber. Subsequently, the stabilization device is no longer functional, the stability of the hoisting engine then no longer being ensured.

There is therefore a need for a stabilization device not having the aforementioned drawbacks. In particular, there is a need for a control system for a stabilizing foot making it possible to increase the security of the known stabilization devices.

To that end, the present invention proposes a system for controlling a stabilizing foot including a hydraulic cylinder and a hydraulic circuit for supplying hydraulic fluid to the hydraulic cylinder, the hydraulic cylinder including a cylinder rod, at the end of which the stabilizing foot can be attached, and at least one hydraulic chamber controlling the position of the cylinder rod, the hydraulic supply circuit including an arm for supplying to the hydraulic chamber, comprising:
first means that can be selectively actuated to prevent the flow of the hydraulic fluid from the hydraulic cylinder, and
second means for preventing a flow of the hydraulic fluid from the hydraulic cylinder while the pressure of the hydraulic fluid in the hydraulic chamber is lower than a predetermined threshold value, the second means being arranged between the first means and the hydraulic chamber.

According to preferred embodiments, the invention comprises one or more of the following features:
the first means are actuated after the second means have allowed the flow of a quantity of hydraulic fluid outside the hydraulic chamber;
the control system further comprises means for determining the position of the rod of the hydraulic cylinder;
the first means are actuated when the rod of the hydraulic cylinder has reached a predetermined boundary position;
the first means include a first check valve that can be actuated selectively;
the second means include a balancing valve and, preferably, a second check valve mounted in parallel with the balancing valve;
the cylinder is a double-acting cylinder, the supply circuit further including a second hydraulic fluid supply arm for a second chamber of the double-acting cylinder; and
a third check valve is formed on the second hydraulic fluid supply arm of the double cylinder, the third check valve being controlled as a function of the second means.

The invention also relates to a stabilization device comprising at least one stabilizing foot and a system for controlling said stabilizing foot as described above in all combinations thereof, the stabilizing foot being hingedly attached to the end of the rod of the cylinder.

The invention further relates to a vehicle, in particular a hoisting engine, comprising a stabilization device as described above.

Other features and advantages of the invention will appear upon reading the following description of one preferred embodiment of the invention, provided as an example and in reference to the appended drawing.

FIG. 1 diagrammatically shows a known stabilization device, in the transport position.

FIG. 2 diagrammatically shows a second known stabilization device, in the transport position.

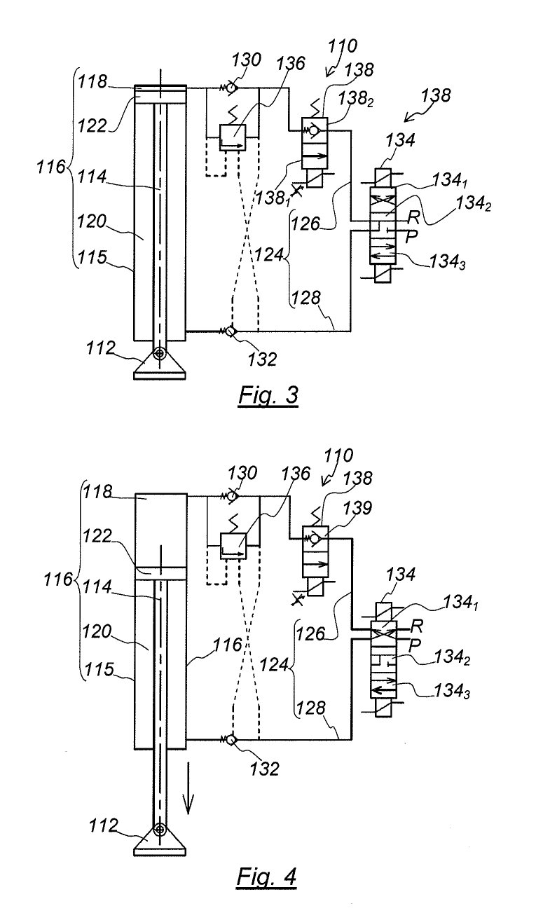

FIG. 3 diagrammatically shows a third stabilization device, in the transport position.

FIG. 4 diagrammatically shows the stabilization device of FIG. 3, during a deployment phase.

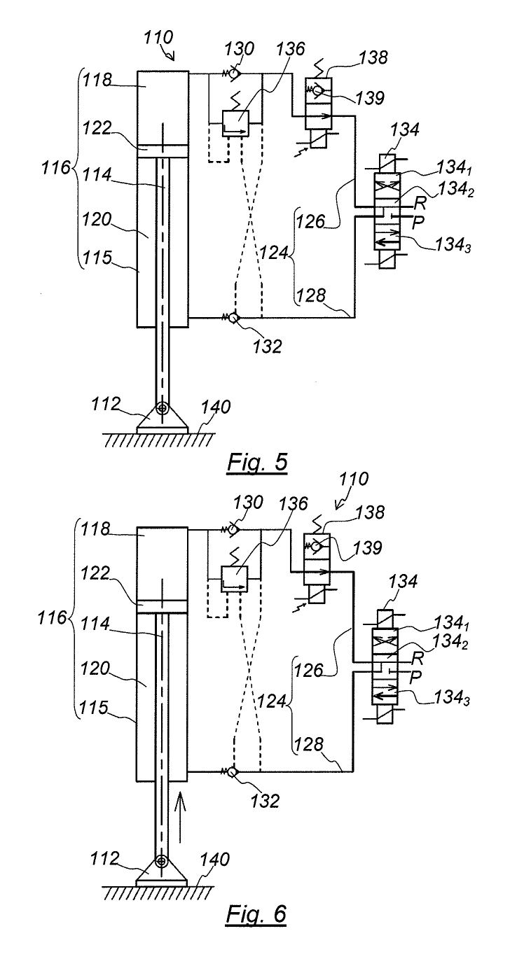

FIG. 5 diagrammatically shows the stabilization device of FIG. 3, in a functional position.

FIG. 6 diagrammatically shows the stabilization device of FIG. 3, during a first failure step.

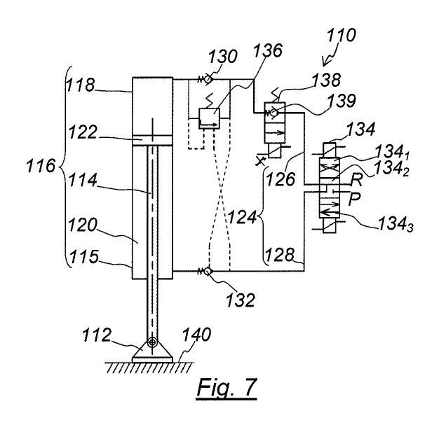

FIG. 7 diagrammatically shows the stabilization device of FIG. 6, during a second failure step.

In the rest of the description, elements of the stabilization device of FIGS. 3 to 7 that are identical or perform an identical function bear the same reference as the corresponding element of the stabilization device of FIG. 1, increased by 100.

As shown in FIGS. 3 to 7, a stabilization device 110 includes a stabilizing foot 112 and a system for controlling the stabilizing foot. Said system for controlling the stabilizing foot includes a hydraulic cylinder 116, the stabilizing foot 112 being attached to the end of the rod 114 of the cylinder 116 in an hingedly manner. Generally, the hydraulic fluid used is oil.

In this application, it is preferable to use a hydraulic cylinder, as this type of cylinder may develop more significant forces and be moved at more precise and more easily adjustable speeds than a pneumatic cylinder in particular. Furthermore, although it is possible to use a single-acting cylinder, it is preferable to use double-acting cylinder to control the movement of the stabilizing foot 112 in two opposite directions.

The double-acting hydraulic cylinder 116 includes a first hydraulic chamber 118 and a second hydraulic chamber 120 separated by a piston 122 secured to the rod 114. A piston joint is provided at the piston 122 to ensure sealing against the hydraulic fluid between the two chambers 118, 120.

The control system also includes a circuit 124 for supplying hydraulic fluid to each of the hydraulic chambers 118, 120 of the hydraulic cylinder 116. The supply circuit 124 may selectively be connected to a pressurized hydraulic fluid source P and/or to a hydraulic fluid reservoir R.

The supply circuit includes a first branch 126 and a second branch 128. The first branch 126 is provided with a first check valve 130 and the second branch 128 is provided with a second check valve 132. The two check valves 130, 132 are of the controlled type and are suitable for preventing a flow of the hydraulic fluid from either of the two chambers 118, 120 of the hydraulic cylinder 116, respectively. Each check valve 130, 132 may be formed by a closing element elastically stressed in a position closing a passage orifice for the hydraulic fluid.

Furthermore, the supply circuit 124 is provided with a control valve 134 with three positions 134₁, 134₂, 134₃.

In a first position 134₁, the valve 134 makes it possible to supply hydraulic fluid to the first hydraulic chamber 118. To that end, the first hydraulic chamber is placed in fluid communication with the pressurized hydraulic fluid source P. Still in this first position 134₁, the valve 134 makes it possible to empty the second hydraulic chamber 120, the second hydraulic chamber 120 being in fluid communication with the hydraulic fluid reservoir R. Subsequently, said first position 134₁ of the control valve 134 controls the exit of the cylinder rod 114 outside the cylinder body 115.

In a second position 134₂, the valve 134 controls an isolation of the pressurized hydraulic fluid source P with respect to the supply circuit 124. Still in the second position 134₂ of the valve 134, the two branches 126, 128 of the supply circuit are in fluid communication with the hydraulic fluid reservoir R. This makes it possible to reduce the pressure of the hydraulic fluid in the arms 126, 128 of the hydraulic circuit. Following this pressure reduction, the check valves 130, 132 close and therefore prevent the discharge of hydraulic fluid from the two hydraulic chambers 118, 120 toward the supply circuit 124 and the hydraulic fluid reservoir R.

In its third position 134₃, the valve 134 makes it possible to supply hydraulic fluid to the second hydraulic chamber 120. To that end, the second hydraulic chamber 120 is placed in fluid communication with the pressurized hydraulic fluid source P. Still in this third position 134₃, the valve 134 makes it possible to empty the first hydraulic chamber 118, the first hydraulic chamber 118 being in fluid communication with the hydraulic fluid reservoir R. Subsequently, said third position 134₃ of the control valve 134 controls the reentry of the cylinder rod 114 in the cylinder body 115.

In parallel with the first check valve 130, the branch 126 of the supply circuit 124 is provided with a balancing valve 136. The balancing valve 136 prevents the flow of the hydraulic fluid from the hydraulic cylinder as long as the pressure of the hydraulic fluid is below a predetermined threshold value. It is known that such any balancing valve 136 allows the passage of the hydraulic fluid only in one direction. That is why it is mounted in parallel with the first check valve 130, which allows a circulation of pressurized hydraulic fluid in the direction opposite the flow allowed by the balancing valve 136.

The first branch 126 of the supply circuit 124 is also provided with a safety solenoid valve 138. The safety solenoid valve 138 is selectively electrically controlled between two positions. In a first position 138₁, the safety solenoid valve 138 behaves like a simple conduit and allows the passage of hydraulic fluid in both directions. In a second position 138₂, the safety solenoid valve 138 behaves like a check valve 139. When the safety solenoid valve 138 is controlled in the second position 138₂, it prevents the flow of the hydraulic fluid from the hydraulic cylinder.

It should be noted here that the assembly formed by the first check valve 130 and the balancing valve 136 is positioned in series between the first hydraulic chamber 118 of the hydraulic cylinder 116 and the safety solenoid valve 138.

The stabilization device 110 further includes means for controlling the control solenoid valve 138, means for determining the position of the hydraulic cylinder rod, and a memory for storing information relative to the position of the hydraulic cylinder rod, not shown. Thus, it is in particular possible to measure the position of the cylinder rod at a given moment, in particular to measure the length by which the cylinder rod has left the cylinder body.

The operation of the stabilization device 110 is described below.

As illustrated in FIG. 3, the stabilization device 110 is in its transport position. In this transport position, the cylinder rod 114 is completely inside the cylinder body 115. In other words, the hydraulic chamber 120 is filled with hydraulic fluid, while the chamber 118 is practically empty. The valve 134 is in its second position 134₂, in which the supply circuit 124 is cut off from the pressurized hydraulic fluid supply source P, the two arms 126, 128 of the supply circuit being in fluid communication with the hydraulic fluid reservoir R. Subsequently, the pressure of the hydraulic fluid in the arms 126, 128 being low, the check valves 130, 132 and 139 are in their closing position, which is a pre-stressed position, thereby preventing any leakage of hydraulic fluid outside the hydraulic chambers 118, 120.

FIG. 4 illustrates the positioning of the stabilization device 110. In this figure, the valve 134 is in the position 134₁ thereof that allows filling of the first chamber 118 with hydraulic fluid coming from the pressurized hydraulic fluid source P, and emptying of the chamber 120 into the hydraulic fluid reservoir R. The safety solenoid valve 138 is in the position 138₂ thereof where it behaves like a check valve 139. The safety solenoid valve 138 is thus also in the idle position thereof, which corresponds to a position where it allows filling of the first chamber 118.

Furthermore, in this position 134₁ of the valve 134, the second hydraulic chamber 120 of the hydraulic cylinder is in fluid communication with the hydraulic fluid reservoir R, by means of the second check valve 132. For the second check valve 132 to allow the passage of hydraulic fluid from the second hydraulic chamber 120 toward the hydraulic fluid reservoir R, a quantity of the hydraulic fluid from the pressurized hydraulic fluid source P is diverted from the first branch 126 of the supply circuit. This quantity of fluid is designed to ensure sufficient pressure at the second check valve 132 for the closing element to be kept away from its closing position, preventing the flow of hydraulic fluid. The closing position of the closing element corresponds to the state of the second check valve 132 in which it prevents the flow of hydraulic fluid from the second hydraulic chamber 120, in the second arm 128 of the supply circuit 124.

The supply of the first hydraulic chamber 118 and the emptying of the second hydraulic chamber cause the cylinder rod 114 to exit the cylinder body, until the stabilizing foot 112 reaches the ground 140 (shown in FIG. 5). The exit of the cylinder rod 114 outside the cylinder body may be continued to reach a stability position of the vehicle on which the stabilization device is mounted.

FIG. 5 shows the stabilization device in the stabilization position thereof. The stabilizing foot 112 rests on the ground 140. The valve 134 is in the position 134₂ thereof where the supply circuit is separated from the pressurized hydraulic fluid source P, the two arms 126, 128 of the hydraulic circuit being in fluid communication with the hydraulic fluid reservoir R. Subsequently, the pressure in the arms 126, 128 between the hydraulic fluid reservoir and the first and second check valves 130, 132 is reduced. Subsequently, the check valves 130 and 132 are closed, due to the pre-stressed assembly of the closing element, in a position where they prevent hydraulic fluid from escaping outside the hydraulic chambers 118, 120. The balancing valve 136 is adjusted to prevent leakage of the hydraulic fluid at the pressure level of the hydraulic fluid in that position. The safety solenoid valve 138 is controlled in its first position 138₁, in which it behaves like a conduit segment, allowing the flow of hydraulic fluid in both directions.

The position of the cylinder rod is then measured, and that information is saved in the storage memory.

FIG. 6 illustrates the appearance of the failure of the hydraulic cylinder of the stabilization device, for example due to an overload. This overload results in an increase in the force applied by the ground 140 on the stabilizing foot 112, and therefore on the cylinder piston 122 by means of the cylinder rod 114.

This increase in the reaction from the ground therefore causes an increase in the pressure of the hydraulic fluid in the first hydraulic chamber 118. When the pressure of the hydraulic fluid in that first chamber becomes higher than a threshold value predetermined as being critical for the integrity of the hydraulic cylinder, the balancing valve, calibrated on said predetermined threshold value, allows hydraulic fluid to leak from the first hydraulic chamber 118.

Thus, since hydraulic fluid is escaping from the first hydraulic chamber by means of the balancing valve 136, the cylinder rod 114 enters the cylinder body 115, despite the position of the check valves 130 and 132.

When the rod of the piston has reached a boundary position (for example identified by its height) predetermined as being critical, in particular for the stability of the vehicle on which the stabilization device is mounted, this height being measured using means for measuring the position of the hydraulic cylinder rod, for example, the safety solenoid valve 138 is controlled in its position 138₂, in which it behaves like a check valve, preventing the flow of hydraulic fluid from the first hydraulic chamber from continuing. This control of the safety solenoid valve 138 thus occurs after the balancing valve has allowed the flow of a quantity of hydraulic fluid outside the first hydraulic chamber 118.

The cylinder rod 114 then stabilizes in this new equilibrium position.

Between the moment where the hydraulic fluid is begun to flow through the balancing valve and the moment where the rod 114 stabilizes, the safety solenoid valve 138 being controlled in its second position 138₂, it is possible to warn the user that the stabilization device is faulty, or at least is not fully functional. This allows the user to take the necessary measures to avoid a complete failure of the stabilization device, which is not possible in the case of the assembly of FIG. 1, with two check valves, for example.

Furthermore, in the case where the balancing valve is adjusted to a too low pressure value—i.e., in the case where the balancing valve has already become open for a too low fluid pressure, which the cylinder is able to support—then the stabilization device according to the invention makes it possible to prevent the first hydraulic chamber 118 from emptying completely, making the balancing device nonfunctional. It should be noted that in that case, the complete emptying of the first balancing chamber is not a priori desired, since the pressure in the first hydraulic chamber 118 is then not of a nature to challenge the integrity of the hydraulic cylinder.

It is also possible to analyze, after stabilization of the cylinder rod 114, the defect(s) that have appeared. After this analysis of the defect(s), only maneuvers that do not worsen the stability or the most suitable maneuvers may be allowed.

Related devices such as those recording the defect or the situation having caused it may be installed so as to facilitate later research.

Lastly, controlled default clearance may also be established.

It should be noted that the stabilization device can be mounted on any type of vehicle needing to be stabilized, whether an automobile or other vehicle. However, the stabilization device is particularly interesting when it is mounted on a construction vehicle, a hoisting engine or a fire truck comprising a ladder or a crane, for example. The stabilization device is therefore particularly applicable when it is used on a vehicle requiring a stabilized position on the ground to ensure user safety.

Of course, the present invention is not limited to the embodiments described and shown, but is open to many alternatives accessible to those skilled in the art.

Thus, it is possible to replace the safety solenoid valve with a check valve that can be actuated selectively, making it possible to interrupt the flow of hydraulic fluid from the hydraulic chamber 118 to the hydraulic fluid reservoir.

The two arms of the hydraulic circuit may also be identical and have the same combination of the safety solenoid valve (or a check valve that can be actuated selectively) with a balancing valve mounted in parallel with the check valve. In this way, the hydraulic cylinder is protected from overpressures of the hydraulic fluid that may appear in each of the two hydraulic chambers of the hydraulic cylinder.

According to another alternative, the hydraulic cylinder may be a single-acting cylinder, the circuit for supplying the stabilization device then comprising a single branch on which the combination of a safety solenoid valve and a balancing valve is mounted in parallel with a check valve.

Lastly, instead of directly measuring the position of the cylinder rod, that position may be deduced from a measurement of a flow rate measurement or a volume of hydraulic fluid provided to either of the hydraulic chambers, or that flows to or from said hydraulic chamber.

1. A system for controlling a stabilizing foot including a hydraulic cylinder and a hydraulic circuit for supplying hydraulic fluid to the hydraulic cylinder, the hydraulic cylinder including a cylinder rod, at the end of which the stabilizing foot can be attached, and at least one hydraulic chamber controlling the position of the cylinder rod, the hydraulic supply circuit including an arm for supplying to the hydraulic chamber, comprising:
first means that can be selectively actuated to prevent the flow of the hydraulic fluid from the hydraulic cylinder, and
second means for preventing a flow of the hydraulic fluid from the hydraulic cylinder while the pressure of the hydraulic fluid in the hydraulic chamber is lower than a predetermined threshold value, the second means being arranged between the first means and the hydraulic chamber.

2. The control system according to claim 1, wherein the first means are actuated after the second means have allowed the flow of a quantity of hydraulic fluid outside the hydraulic chamber.

3. The control system according to claim 1, further comprising means for determining the position of the rod of the hydraulic cylinder.

4. The control system according to claim 3, wherein the first means are actuated when the rod of the hydraulic cylinder has reached a predetermined boundary position.

5. The control system according to claim 1, wherein the first means include a first check valve that can be actuated selectively.

6. The control system according to claim 1, wherein the second means include a balancing valve and, preferably, a second check valve mounted in parallel with the balancing valve.

7. The control system according to claim 1, wherein the cylinder is a double-acting cylinder, the supply circuit further including a second hydraulic fluid supply arm for a second chamber of the double-acting cylinder.

8. The control system according to claim 7, wherein a third check valve is formed on the second hydraulic fluid supply arm of the double cylinder, the third check valve being controlled as a function of the second means.

9. A stabilization device comprising at least one stabilizing foot and a system for controlling said stabilizing foot, the system for controlling including a hydraulic cylinder and a hydraulic circuit for supplying hydraulic fluid to the hydraulic cylinder, the hydraulic cylinder including a cylinder rod, at the end of which the stabilizing foot can be attached, and at least one hydraulic chamber controlling the position of the cylinder rod, the hydraulic supply circuit including an arm for supplying to the hydraulic chamber, comprising:
first means that can be selectively actuated to prevent the flow of the hydraulic fluid from the hydraulic cylinder, and
second means for preventing a flow of the hydraulic fluid from the hydraulic cylinder while the pressure of the hydraulic fluid in the hydraulic chamber is lower than a predetermined threshold value, the second means being arranged between the first means and the hydraulic chamber,
wherein the stabilizing foot is hingedly attached to the end of the rod of the cylinder.

10. (canceled)

11. The stabilization device according to claim 9, wherein the first means are actuated after the second means have allowed the flow of a quantity of hydraulic fluid outside the hydraulic chamber.

12. The stabilization device according to claim 9, further comprising means for determining the position of the rod of the hydraulic cylinder.

13. The stabilization device according to claim 12, wherein the first means are actuated when the rod of the hydraulic cylinder has reached a predetermined boundary position.

14. The stabilization device according to claim 9, wherein the first means include a first check valve that can be actuated selectively, the second means including a balancing valve and, preferably, a second check valve mounted in parallel with the balancing valve.

15. The stabilization device according to claim 9, wherein the cylinder is a double-acting cylinder, the supply circuit further including a second hydraulic fluid supply arm for a second chamber of the double-acting cylinder, a third check valve being formed on the second hydraulic fluid supply arm of the double cylinder, the third check valve being controlled as a function of the second means.

16. A vehicle, in particular a hoisting engine, comprising a stabilization device comprising at least one stabilizing foot and a system for controlling said stabilizing foot, the system for controlling including a hydraulic cylinder and a hydraulic circuit for supplying hydraulic fluid to the hydraulic cylinder, the hydraulic cylinder including a cylinder rod, at the end of which the stabilizing foot can be attached, and at least one hydraulic chamber controlling the position of the cylinder rod, the hydraulic supply circuit including an arm for supplying to the hydraulic chamber, comprising:
first means that can be selectively actuated to prevent the flow of the hydraulic fluid from the hydraulic cylinder, and
second means for preventing a flow of the hydraulic fluid from the hydraulic cylinder while the pressure of the hydraulic fluid in the hydraulic chamber is lower than a predetermined threshold value, the second means being arranged between the first means and the hydraulic chamber, wherein the stabilizing foot is hingedly attached to the end of the rod of the cylinder.

17. The vehicle according to claim 16, wherein the first means are actuated after the second means have allowed the flow of a quantity of hydraulic fluid outside the hydraulic chamber.

18. The vehicle according to claim 16, further comprising means for determining the position of the rod of the hydraulic cylinder.

19. The vehicle according to claim 18, wherein the first means are actuated when the rod of the hydraulic cylinder has reached a predetermined boundary position.

20. The vehicle according to claim 16, wherein the first means include a first check valve that can be actuated selectively, the second means including a balancing valve and, preferably, a second check valve mounted in parallel with the balancing valve.

21. The vehicle according to claim 16, wherein the cylinder is a double-acting cylinder, the supply circuit further including a second hydraulic fluid supply arm for a second chamber of the double-acting cylinder, a third check valve being formed on the second hydraulic fluid supply arm of the double cylinder, the third check valve being controlled as a function of the second means.
